(19) United States
(12) Patent Application Publication
(10) Pub. No.: US 2025/0164682 A1
(43) Pub. Date: May 22, 2025

(54) DEVICES AND SYSTEMS FOR LIGHT-RECYCLING WAVEGUIDES

(71) Applicant: Meta Platforms Technologies, LLC, Menlo Park, CA (US)

(72) Inventors: Ali Altaqui, Raleigh, NC (US); Xiayu Feng, Kirkland, WA (US); Jihwan Kim, Cary, NC (US); Sihui He, Sunnyvale, CA (US); Yun-Han Lee, Redmond, WA (US); Steven John Robbins, Redmond, WA (US); Michael Escuti, Redmond, WA (US); Lu Lu, Kirkland, WA (US)

(21) Appl. No.: 18/409,194

(22) Filed: Jan. 10, 2024

Related U.S. Application Data
(60) Provisional application No. 63/601,368, filed on Nov. 21, 2023.

(51) Int. Cl. F21V 8/00; G02B 5/30; G02B 5/32

(52) U.S. Cl. CPC G02B 6/0026; G02B 5/3016; G02B 5/32; G02B 6/0055; G02B 6/0056; G02B 6/0088

(57) ABSTRACT

The disclosed device may include a waveguide; an output coupler that couples electromagnetic radiation from within the waveguide to outside of the waveguide; and a reflector positioned on an opposite side of the waveguide from the output coupler, where the reflector reflects electromagnetic radiation that leaks from the waveguide through the opposite side of the waveguide back toward the output coupler. Various other devices, systems, and methods are also disclosed.

### RELATED APPLICATION DATA

This application claims the benefit of U.S. Application No. 63/479,396, filed 11 Jan. 2023, and U.S. Application No. 63/601,368, filed 21 Nov. 2023, the disclosures of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example waveguide with light leakage.

FIG. 2 illustrates an example waveguide with a spatially varying retardation compensator.

FIG. 3 illustrates an example waveguide with a depolarizer.

FIG. 4 illustrates an example light-recycling waveguide device.

FIG. 5 illustrates the light-recycling waveguide device of FIG. 4 with depolarizers.

FIG. 6. illustrates an example light-recycling waveguide device.

FIG. 7 illustrates an example light-recycling waveguide device.

FIG. 8 illustrates an example light-recycling waveguide device.

FIG. 9 illustrates an example light-recycling waveguide device.

FIG. 10 illustrates an example light-recycling waveguide device.

FIG. 11 is a diagram of a head-mounted display (HMD) that includes a near-eye display (NED) according to some embodiments.

FIG. 12 is a cross-sectional view of the HMD illustrated in FIG. 11 according to some embodiments.

FIG. 13 illustrates an isometric view of a waveguide display in accordance with various embodiments.

FIG. 14 is a cross-sectional view of a waveguide display according to some embodiments.

FIG. 15 shows an example waveguide display including an array of decoupling elements each having an over-formed reflector according to various embodiments.

FIG. 16 shows an example waveguide display including an array of decoupling elements each having an over-formed reflector according to further embodiments.

FIG. 17 is an illustration of exemplary augmented-reality glasses that may be used in connection with embodiments of this disclosure.

FIG. 18 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Waveguides are used in various applications, including virtual reality (VR) and augmented reality (AR). Across these applications, various performance characteristics of waveguides may be important, including efficiency. Some waveguide designs may lead to efficiency loss of the eye-side signal as well as world-side leakage due to, e.g., polarization-sensitive output couplers. For example, polarization volume hologram (PVH) gratings may be polarization sensitive. However, polarization states within the waveguide may be difficult to manage due to many total internal reflections.

Waveguide designs described herein may “recycle” leakage with a reflector opposite the output coupler. In some examples, the reflector design may be optimized to reflect light with a corrected polarization to pass through the output coupler. (While, in various examples, uses cases of the devices and systems described herein may be focused on visible light, as used herein, the term “light” may also be used as a shorthand for electromagnetic radiation, including electromagnetic radiation outside of the visible light spectrum.) Thus, for example, the reflector may be a reflective cholesteric liquid crystal (CLC) polymer film or a 50:50 mirror, depending on whether the polarity is to be flipped or not. In some examples, a transmissive PVH (T-PVH) grating may be placed between the waveguide and the reflector to redirect beams to interpupil replication locations, thereby increasing the density of sampling for the eye-box. Furthermore, in some examples, depolarizers may be placed on either side of the waveguide surface to ensure that light is fully depolarized before reaching the output coupler. In one example, the reflector stack may include an achromatic quarter-wave plate and a reflective polarizer, which may further reduce leakage relative to a CLC-based reflector. Some reflectors (such as CLC or reflective polarizers) may reduce the world-side signal, potentially improving contrast for AR systems may improving the ratio between eye-side and world-side signals. Another reflector configuration may include a reflective PVH (R-PVH) with periodic variation such that it accommodates both normally incident and total-internal-reflection incident waves.

By recycling light that would otherwise escape from a waveguide, the devices and systems described herein may increase the efficiency of waveguides (e.g., the efficiency of the eye-side signal of waveguides in AR/VR applications) and/or reduce leakage of waveguides, thereby potentially improving the performance of waveguides, including, e.g., improving user experience in AR/VR applications. Furthermore, in some examples these devices and systems may increase the density of sampling for the eye-box (e.g., in AR/VR applications), thereby potentially improving user experience.

Furthermore, in some examples, a waveguide display system may include a micro-display module and waveguide optics for directing a display image to a user. The micro-display module may include a light source, such as a light emitting diode (LED). The waveguide optics may include input-coupling and output-coupling elements such as surface relief gratings that are configured to couple light into and out of the waveguide. Example grating structures may have a two-dimensional periodicity. In some embodiments, a vertical grating coupler, for instance, may be configured to change an out-of-plane wave-vector direction of light to an in-plane waveguide direction, or vice versa, and accordingly direct the passage of light through the waveguide display.

In some example systems, the waveguide optics may be advantageously configured to create illuminance uniformity and a wide field of view (FOV). The FOV relates to the angular range of an image observable by a user, whereas illuminance uniformity may include both the uniformity of image light over an expanded exit pupil (exit pupil uniformity) and the uniformity of image light over the FOV (angular uniformity). As will be appreciated, an input-coupling grating may determine the angular uniformity and coupling efficiency of image light.

Some devices and systems described herein may provide performance-enhancing waveguide optics, and particularly input-coupling and output-coupling elements that are economical to manufacture while exhibiting improved design flexibility and functionality. In accordance with various embodiments, a waveguide display system may include an array of discrete output-coupling elements that are co-integrated with reflective layers that are configured to inhibit the loss of image light. A reflective layer may be disposed over each respective output-coupling element. The reflective layers may be adapted to redirect image light decoupled from the waveguide in the direction of the world side of the display system back to the eye of a user.

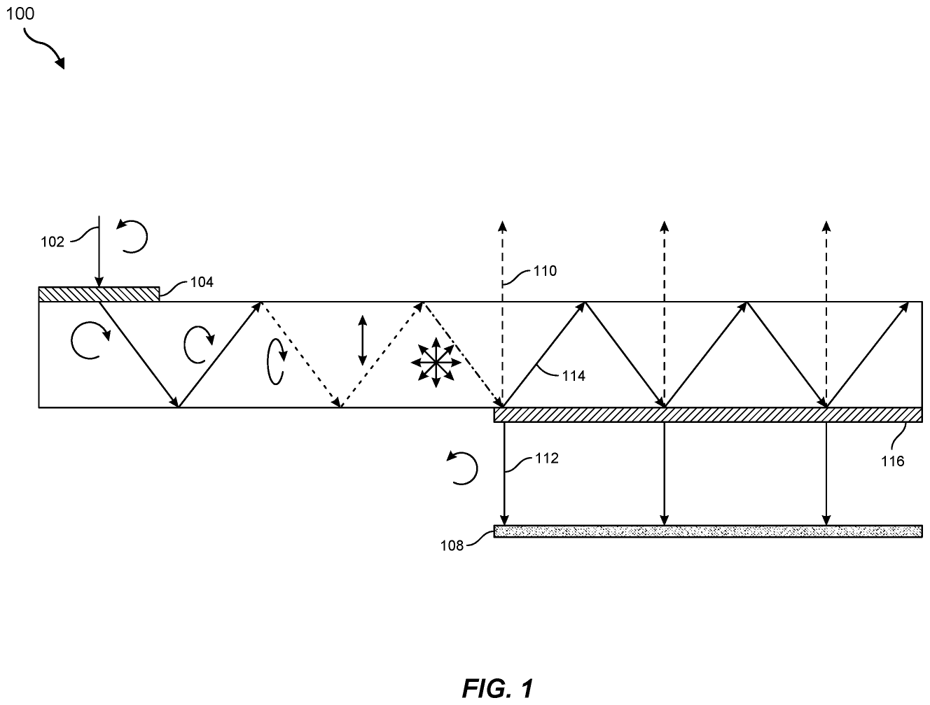

FIG. 1 illustrates an example waveguide 100 with light leakage. As shown in FIG. 1, waveguide 100 may include an input coupler 104 and an output coupler 116. Light 102 may enter waveguide 100 via input coupler 104 and exit waveguide 100 at one or more positions of output coupler 116 and, thus, reach one or more positions of a target 108. In some examples, target 108 may be an eye box. For example, waveguide 100 may be a part of a head-mounted display for a VR/AR application.

In some examples, input coupler 104 and/or output coupler 116 may be polarization sensitive. For example, input coupler 104 and/or output coupler 116 may be optimized for right-handed circularly polarized light (or for left-handed circularly polarized light) to improve efficiency. In one example, input coupler 104 and/or output coupler 116 may include a transmissive polarization volume hologram. As shown in FIG. 1, light 102 may be fully right-handed circularly polarized before entering waveguide 100 and may be fully left-handed circularly polarized after passing through input coupler 104. However, due to multiple total internal reflections, the polarization states of light 102 incident on output coupler 116 may be randomized. This may cause reduction in the diffraction efficiency of output coupler 116 and/or may contribute to light leakage (i.e., away from target 108, as shown with light part 110). By way of example, at the first illustrated incidence of light 102 on output coupler 116, light 102 may be split into light part 110, a light part 112, and a light part 114.

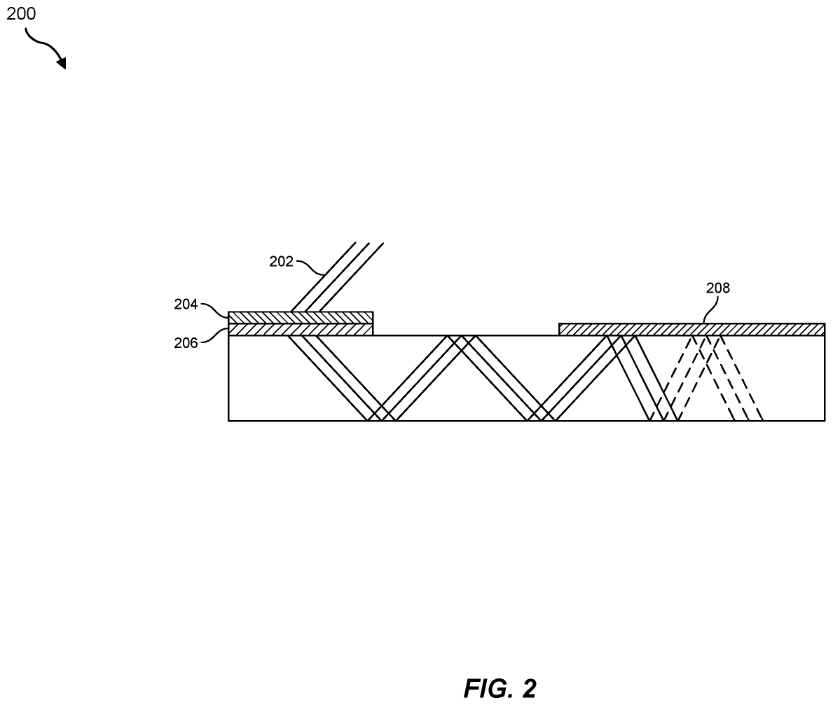

FIG. 2 illustrates an example waveguide 200 with a spatially varying retardation compensator 206. As shown in FIG. 2, light 202 may enter waveguide 200 via an input coupler 204 (e.g., a transmissive polarization volume hologram) and spatially varying retardation compensator 206. As an alternative, spatially varying retardation compensator 206 may be placed at output coupler 208. The inclusion of spatially varying retardation compensator 206 at input coupler 204 or output coupler 208 may allow partial control of the phase difference between the orthogonal polarization states incident on an output coupler 208 (e.g., a transmissive polarization volume hologram). However, this approach may not be effective for all angles of incidence and for all wavelengths.

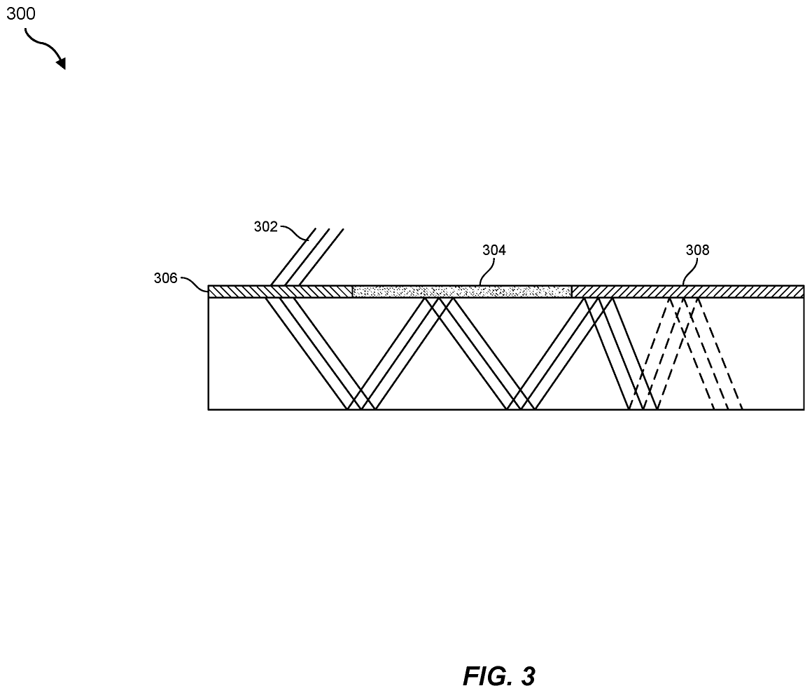

FIG. 3 illustrates an example waveguide 300 with a depolarizer 304. As shown in FIG. 3, light 302 may enter waveguide 300 via an input coupler 306 (e.g., a transmissive polarization volume hologram). The polarization of light within waveguide 300 may be varied by depolarizer 304 such that the average polarization of light 302 within waveguide 300 over time is effectively randomized. Thus, the efficiency of output coupler 308 (e.g., a transmissive polarization volume hologram) may not be maximized, although the efficiency of output coupler 308 may be homogenized.

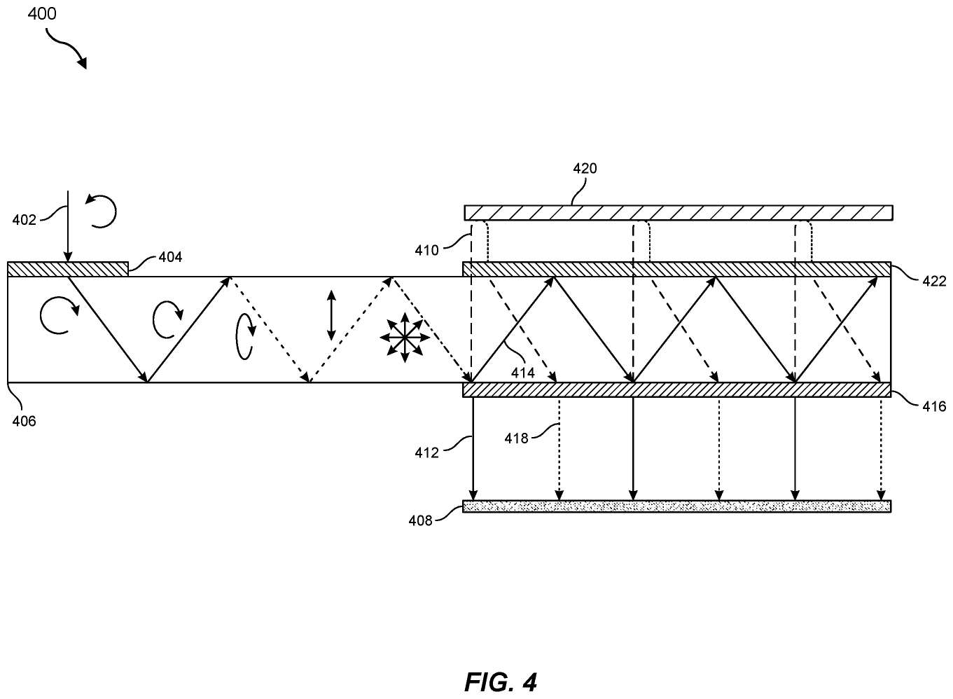

FIG. 4 illustrates an example light-recycling waveguide device 400. As shown in FIG. 4, device 400 may include a waveguide 406 and a reflector 420. Waveguide 406 may include an input coupler 404, an output coupler 416, and a transmissive polarization volume hologram 422.

Light 402 may enter waveguide 406 via input coupler 404 and exit device 400 at one or more positions of output coupler 416 and, thus, reach one or more positions of a target 408. In some examples, target 408 may be an eye box. For example, device 400 may be a part of a head-mounted display for a VR/AR application.

In some examples, input coupler 404 and/or output coupler 416 may be polarization sensitive. For example, input coupler 404 and/or output coupler 416 may be optimized for right-handed circularly polarized light (or for left-handed circularly polarized light) to improve efficiency. In one example, input coupler 404 and/or output coupler 416 may include a transmissive polarization volume hologram. As shown in FIG. 4, light 402 may be fully right-handed circularly polarized before entering device 400 and may be fully left-handed circularly polarized after passing through input coupler 404. However, due to multiple total internal reflections, the polarization states of light 402 incident on output coupler 416 may be randomized. This may cause initial light leakage (i.e., away from target 408, as shown with light part 410). By way of example, at the first illustrated incidence of light 402 on output coupler 416, light 402 may be split into light part 410, a light part 412, and a light part 414.

Light part 410 may be left-handed circularly polarized when leaving waveguide 406. Reflector 420 may reflect light part 410 back toward waveguide 406. In addition, light part 410, after reflection, may be right-handed circularly polarized. When light part 410 reenters waveguide 406 via transmissive polarization volume hologram 422, light part 410 may be diffracted (and become left-handed circularly polarized). When light part 410 exits via output coupler 416, light part 410 may be right-handed circularly polarized again, and may result in a replication 418 of light part 412 (e.g., an interpupil replication on target 408).

Reflector 420 may be any suitable type of reflecting element. In one example, reflector 420 may be a 50:50 mirror. In some examples, a variation of device 400 may preserve the handedness of the circular polarization of light part 410 after reflection from reflector 420. In these examples, reflector 420 may be a reflective cholesteric liquid crystal polymer film.

As may be appreciated, device 400 may provide improved waveguide functionality. For example, where device 400 is used in a head-mounted display, by recycling light part 410 that leaks from waveguide 406 to become a replication 418 of light part 412, device 400 may demonstrate increased efficiency, reduced world-side leakage, improved contrast, and densely sample the eye box by providing interpupil replications.

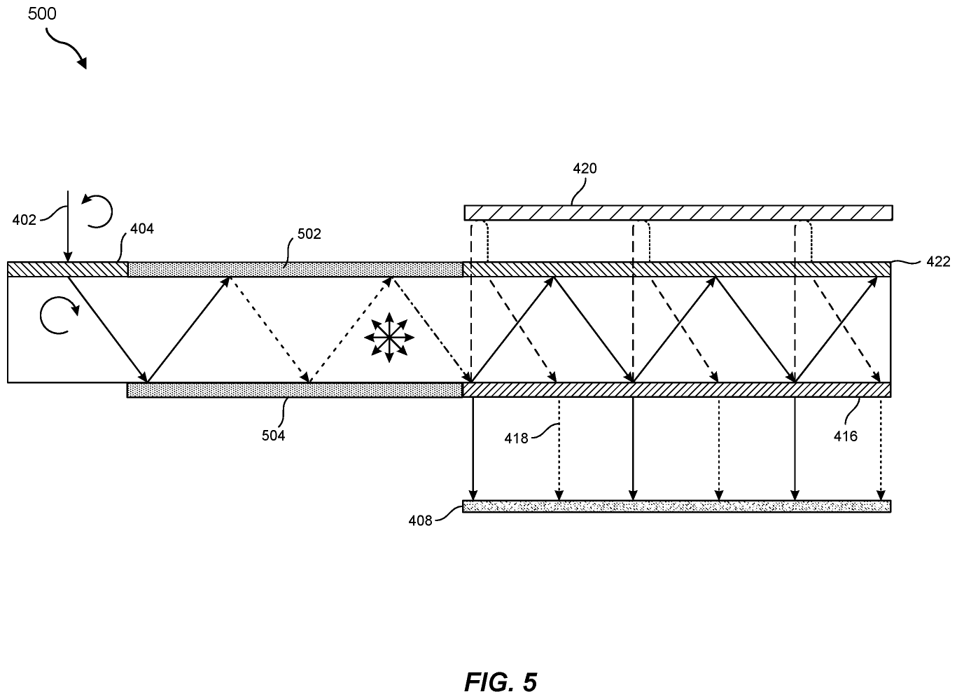

FIG. 5 illustrates the light-recycling waveguide device 500 of FIG. 4 with depolarizers 502 and 504. Including one or more depolarizers in the light path between input coupler 404 and output coupler 416, may increase the depolarization of light 402 by the time it reaches output coupler 416, thereby increasing the homogeneity of the effect of the performance of output coupler 416 (and, thus, of interpupil replications).

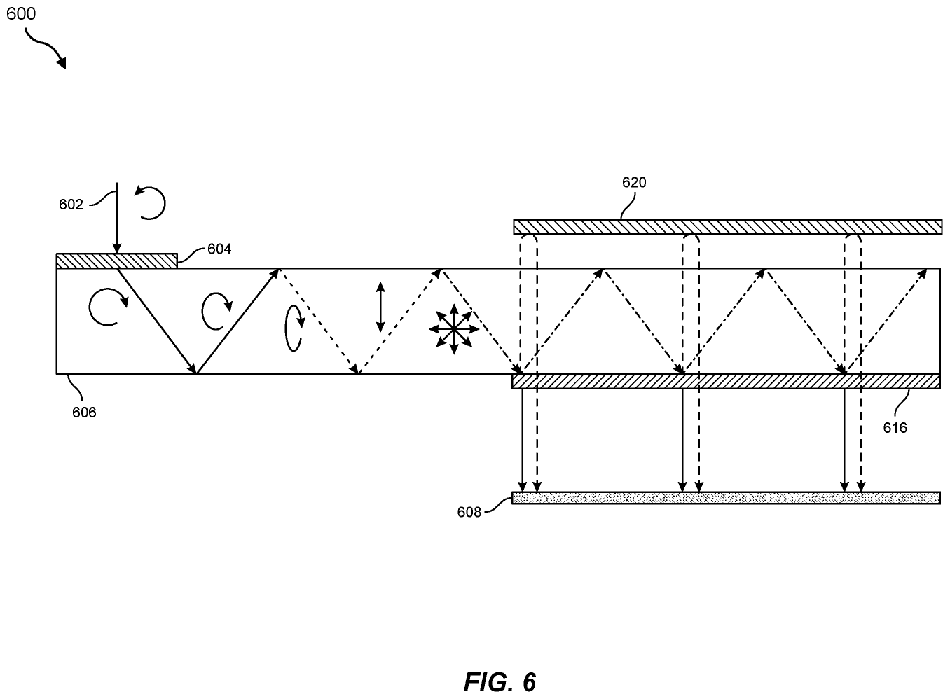

FIG. 6. illustrates an example light-recycling waveguide device 600. As shown in FIG. 6, device 600 may include a waveguide 606 and a reflector 620. Waveguide 606 may include an input coupler 604 and an output coupler 616.

Light 602 may enter waveguide 606 via input coupler 604 and exit device 600 at one or more positions of output coupler 616 and, thus, reach one or more positions of a target 608. In some examples, target 608 may be an eye box. For example, device 600 may be a part of a head-mounted display for a VR/AR application.

In some examples, input coupler 604 and/or output coupler 616 may be polarization sensitive. For example, input coupler 604 and/or output coupler 616 may be optimized for right-handed circularly polarized light (or for left-handed circularly polarized light) to improve efficiency. In one example, input coupler 604 and/or output coupler 616 may include a transmissive polarization volume hologram. As shown in FIG. 6, light 602 may be fully right-handed circularly polarized before entering device 600 and may be fully left-handed circularly polarized after passing through input coupler 604. However, due to multiple total internal reflections, the polarization states of light 602 incident on output coupler 616 may be randomized. This may cause initial light leakage. However, reflector 620 may reflect leaked light back toward target 608.

Reflector 620 may be any suitable type of reflecting element. In one example, reflector 620 may be a cholesteric liquid crystal polymer film (preserving the handedness of the circular polarity of incident light, which may then pass through output coupler 616).

As may be appreciated, device 600 may provide improved waveguide functionality. For example, where device 600 is used in a head-mounted display, by recycling light that leaks from waveguide 606 to be directed toward target 608 (e.g., an eye box), device 600 may demonstrate increased efficiency, reduced world-side leakage, and improved contrast.

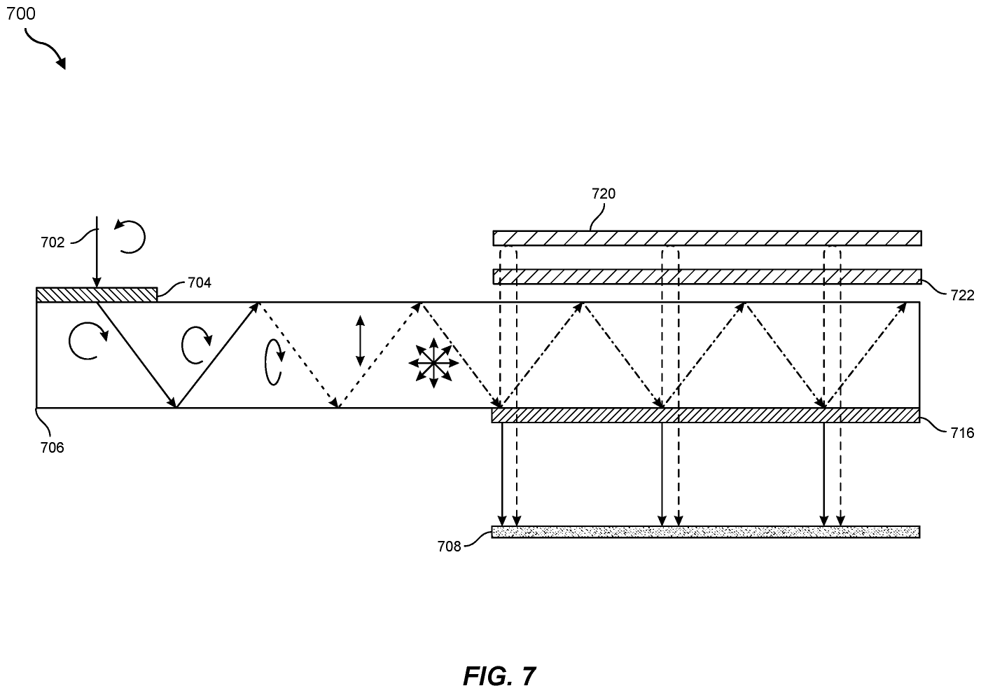

FIG. 7 illustrates an example light-recycling waveguide device 700. As shown in FIG. 7, device 700 may include a waveguide 706, a reflective polarizer 720, and an achromatic quarter-wave plate 722. Waveguide 706 may include an input coupler 704 and an output coupler 716.

Light 702 may enter waveguide 706 via input coupler 704 and exit device 700 at one or more positions of output coupler 716 and, thus, reach one or more positions of a target 708. In some examples, target 708 may be an eye box. For example, waveguide 706 may be a part of a head-mounted display for a VR/AR application.

In some examples, input coupler 704 and/or output coupler 716 may be polarization sensitive. For example, input coupler 704 and/or output coupler 716 may be optimized for right-handed circularly polarized light (or for left-handed circularly polarized light) to improve efficiency. In one example, input coupler 704 and/or output coupler 716 may include a transmissive polarization volume hologram. As shown in FIG. 7, light 702 may be fully right-handed circularly polarized before entering device 700 and may be fully left-handed circularly polarized after passing through input coupler 704. However, due to multiple total internal reflections, the polarization states of light 702 incident on output coupler 716 may be randomized. This may cause initial light leakage. However, achromatic quarter-wave plate 722 and reflective polarizer 720 in tandem may reflect leaked light back toward target 708.

For example, achromatic quarter-wave plate 722 may linearly polarize the leaked light, which may then be reflected as linearly polarized light by reflective polarizer 720, pass back through achromatic quarter-wave plate 722, and become circularly polarized (e.g., left-handed circularly polarized) again. In some examples, reflective polarizer 720 may reduce light leakage compared to other reflectors.

As may be appreciated, device 700 may provide improved waveguide functionality. For example, where device 700 is used in a head-mounted display, by recycling light that leaks from waveguide 706 to be directed toward target 708 (e.g., an eye box), device 700 may demonstrate increased efficiency, reduced world-side leakage, and improved contrast.

In some examples, the devices of FIGS. 4-7 may reduce a world-side signal by 50% (e.g., in an AR application). This may potentially improve a world-to-display contrast ratio. In other examples (e.g., in a VR application), the reflector may be a simple mirror.

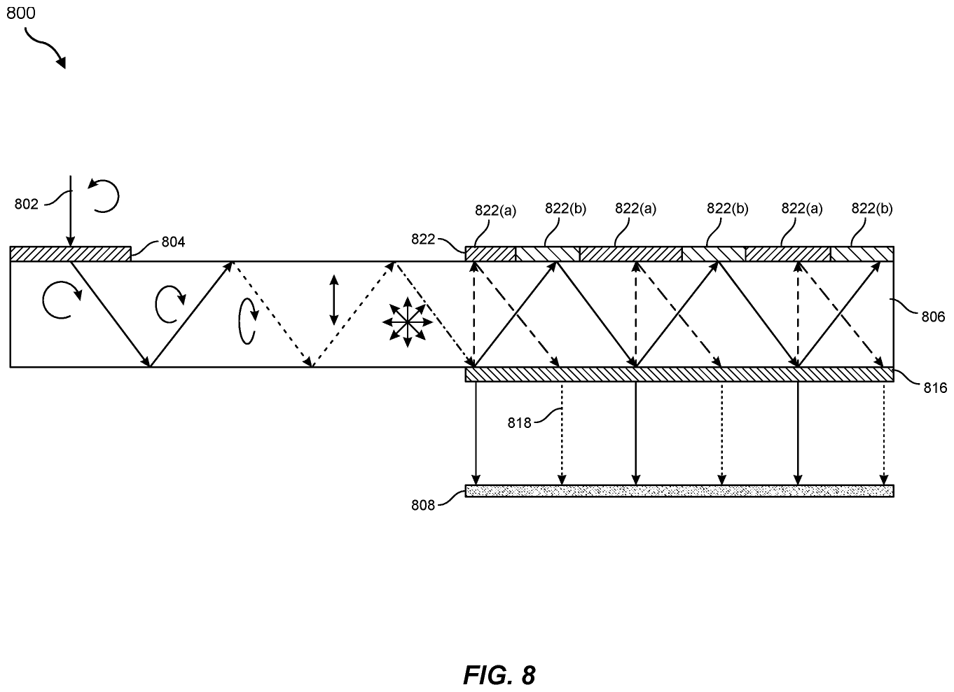

FIG. 8 illustrates an example light-recycling waveguide device 800. As shown in FIG. 8, device 800 may include an input coupler 804, an output coupler 816, and a reflective polarization volume hologram 822.

Light 802 may enter waveguide 806 via input coupler 804 and exit device 800 at one or more positions of output coupler 816 and, thus, reach one or more positions of a target 808. In some examples, target 808 may be an eye box. For example, waveguide 806 may be a part of a head-mounted display for a VR/AR application.

In some examples, input coupler 804 and/or output coupler 816 may be polarization sensitive. For example, input coupler 804 and/or output coupler 816 may be optimized for right-handed circularly polarized light (or for left-handed circularly polarized light) to improve efficiency. In one example, input coupler 804 and/or output coupler 816 may include a transmissive polarization volume hologram. As shown in FIG. 8, light 802 may be fully right-handed circularly polarized before entering device 800 and may be fully left-handed circularly polarized after passing through input coupler 804. However, due to multiple total internal reflections, the polarization states of light 802 incident on output coupler 816 may be randomized.

Reflective polarization volume hologram 822 may have periodic variation in the Bragg plane. Thus, for example, sections 822(a) of polarization volume hologram 822 may reflect normally incident light (that would otherwise leak) from waveguide 800) back toward target 808, resulting in replications 818. Sections 822(b) of polarization volume hologram 822 may reflect total internal reflection incident light to continue along the waveguide.

As may be appreciated, waveguide 800 may provide improved functionality. For example, where waveguide 800 is used in a head-mounted display, by reflecting light that would otherwise leak from waveguide 800 to become a replication 818, waveguide 800 may demonstrate increased efficiency, reduced world-side leakage, improved contrast, and densely sample the eye box by providing interpupil replications.

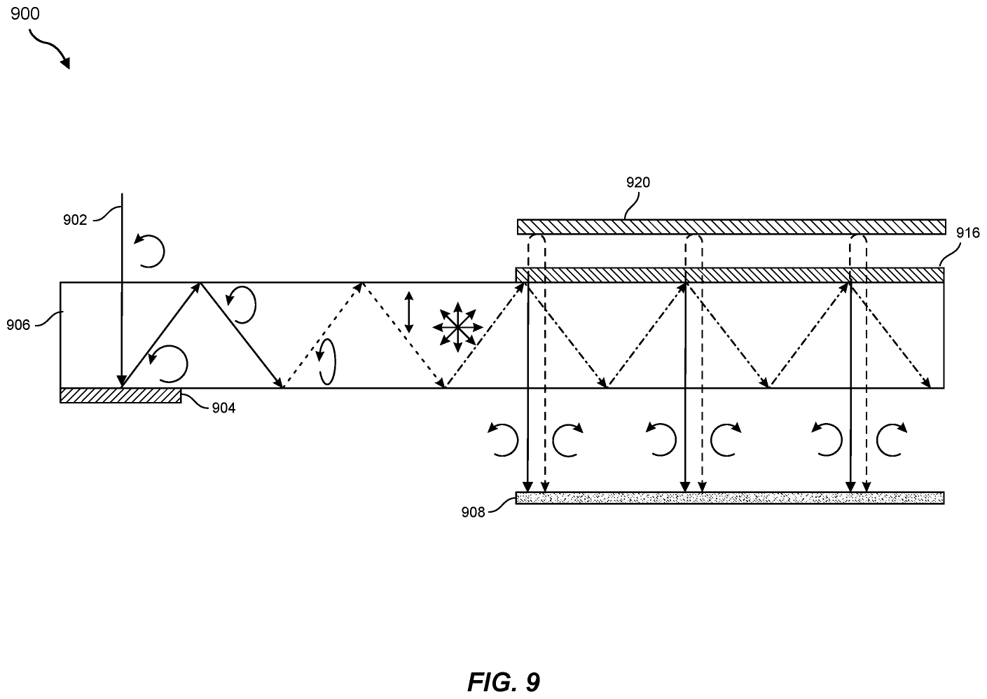

FIG. 9 illustrates an example light-recycling waveguide device 900. As shown in FIG. 9, device 900 may include a waveguide 906, a reflector 920, and an achromatic quarter-wave plate 922. Waveguide 906 may include an input coupler 904 and an output coupler 916.

Light 902 may enter waveguide 906 and then enter total internal reflection via input coupler 904 and exit device 900 at one or more positions of output coupler 916 and, thus, reach one or more positions of a target 908. In some examples, target 908 may be an eye box. For example, waveguide 906 may be a part of a head-mounted display for a VR/AR application.

In some examples, input coupler 904 and/or output coupler 916 may be polarization sensitive. For example, input coupler 904 and/or output coupler 916 may be optimized for left-handed circularly polarized light (or for right-handed circularly polarized light) to improve efficiency. In one example, input coupler 904 and/or output coupler 916 may include a reflective polarization volume hologram. As shown in FIG. 9, light 902 may be fully left-handed circularly polarized before entering device 900 and may be fully left-handed circularly polarized after reflecting from input coupler 904. However, due to multiple total internal reflections, the polarization states of light 902 incident on output coupler 916 may be randomized. This may cause initial light leakage. However, reflector 920 (e.g., a reflective cholesteric liquid crystal (CLC) polymer film) may reflect leaked light back toward target 908.

As may be appreciated, device 900 may provide improved waveguide functionality. For example, where device 900 is used in a head-mounted display, by recycling light that leaks from waveguide 906 to be directed toward target 908 (e.g., an eye box), device 900 may demonstrate increased efficiency, reduced world-side leakage, and improved contrast.

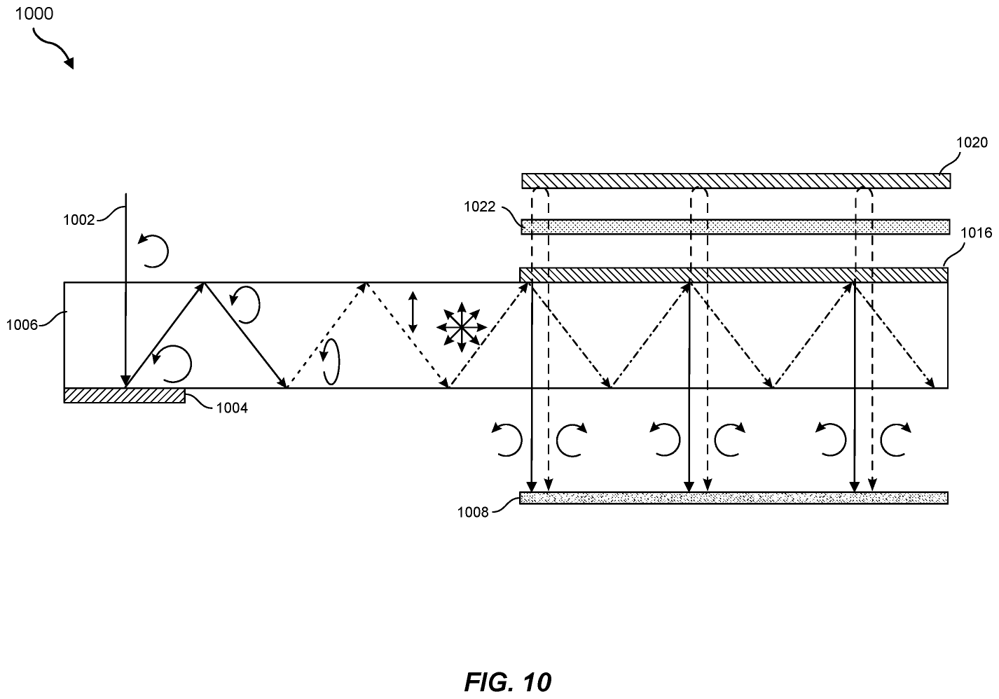

FIG. 10 illustrates an example light-recycling waveguide device 1000. As shown in FIG. 10, device 1000 may include a waveguide 1006, a reflective polarizer 1020, and an achromatic quarter-wave plate 1022. Waveguide 1006 may include an input coupler 1004 and an output coupler 1016.

Light 1002 may enter waveguide 1006 and then enter total internal reflection via input coupler 1004 and exit device 1000 at one or more positions of output coupler 1016 and, thus, reach one or more positions of a target 1008. In some examples, target 1008 may be an eye box. For example, waveguide 1006 may be a part of a head-mounted display for a VR/AR application.

In some examples, input coupler 1004 and/or output coupler 1016 may be polarization sensitive. For example, input coupler 1004 and/or output coupler 1016 may be optimized for left-handed circularly polarized light (or for right-handed circularly polarized light) to improve efficiency. In one example, input coupler 1004 and/or output coupler 1016 may include a reflective polarization volume hologram. As shown in FIG. 10, light 1002 may be fully left-handed circularly polarized before entering device 1000 and may be fully left-handed circularly polarized after reflecting from input coupler 1004. However, due to multiple total internal reflections, the polarization states of light 1002 incident on output coupler 1016 may be randomized. This may cause initial light leakage. However, achromatic quarter-wave plate 1022 and reflective polarizer 1020 in tandem may reflect leaked light back toward target 1008.

For example, achromatic quarter-wave plate 1022 may linearly polarize the leaked light, which may then be reflected as linearly polarized light by reflective polarizer 1020, pass back through achromatic quarter-wave plate 1022, and become circularly polarized (e.g., right-handed circularly polarized) again. In some examples, reflective polarizer 1020 may reduce light leakage compared to other reflectors.

As may be appreciated, device 1000 may provide improved waveguide functionality. For example, where device 1000 is used in a head-mounted display, by recycling light that leaks from waveguide 1006 to be directed toward target 1008 (e.g., an eye box), device 1000 may demonstrate increased efficiency, reduced world-side leakage, and improved contrast.

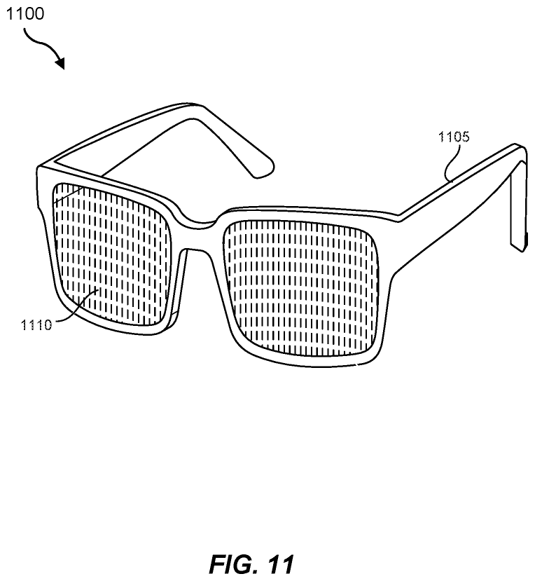

FIG. 11 is a diagram of a near-eye-display (NED), in accordance with some embodiments. The NED 1100 may present media to a user. Examples of media that may be presented by the NED 1100 include one or more images, video, audio, or some combination thereof. In some embodiments, audio may be presented via an external device (e.g., speakers and/or headphones) that receives audio information from the NED 1100, a console (not shown), or both, and presents audio data to the user based on the audio information. The NED 1100 is generally configured to operate as an augmented reality (AR) NED. However, in some embodiments, the NED 1100 may be modified to also operate as a virtual reality (VR) NED, a mixed reality (MR) NED, or some combination thereof. By way of example, in some embodiments, the NED 1100 may augment views of a physical, real-world environment with computer-generated elements (e.g., still images, video, sound, etc.).

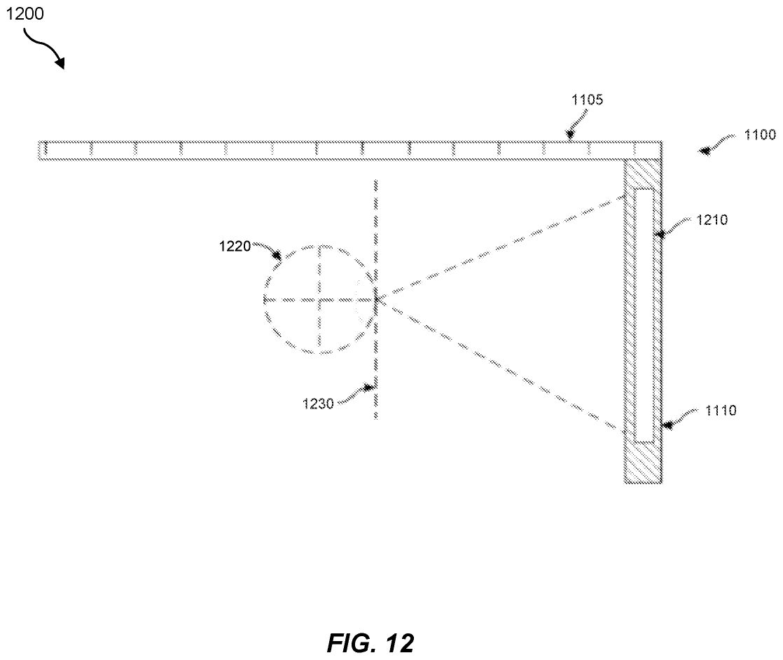

The NED 1100 shown in FIG. 11 may include a frame 1105 and a display 1110. The frame 1105 may include one or more optical elements that together display media to a user. That is, the display 1110 may be configured for a user to view the content presented by the NED 1100. As discussed below in conjunction with FIG. 12, the display 1110 may include at least one source assembly to generate image light to present optical media to an eye of the user. The source assembly may include, e.g., a source, an optics system, or some combination thereof.

It will be appreciated that FIG. 11 is merely an example of an augmented reality system, and the display systems described herein may be incorporated into further such systems. In some embodiments, FIG. 11 may also be referred to as a head-mounted display (HMD).

FIG. 12 is a cross section 1200 of the NED 1100 illustrated in FIG. 11, in accordance with some embodiments of the present disclosure. The cross section 1200 may include at least one display assembly 1210 and an exit pupil 1230. The exit pupil 1230 is a location where the eye 1220 may be positioned when a user wears the NED 1100. In some embodiments, the frame 1105 may represent a frame of eye-wear glasses. For purposes of illustration, FIG. 12 shows the cross section 1200 associated with a single eye 1220 and a single display assembly 1210, but in alternative embodiments not shown, another display assembly that is separate from or integrated with the display assembly 1210 shown in FIG. 12, may provide image light to another eye of the user.

The display assembly 1210 may be configured to direct image light to the eye 1220 through the exit pupil 1230. The display assembly 1210 may be composed of one or more materials (e.g., plastic, glass, etc.) with one or more refractive indices that effectively decrease the weight and widen a field of view of the NED 1100.

In alternate configurations, the NED 1100 may include one or more optical elements (not shown) located between the display assembly 1210 and the eye 1220. The optical elements may act to, by way of various examples, correct aberrations in image light emitted from the display assembly 1210, magnify image light emitted from the display assembly 1210, perform some other optical adjustment of image light emitted from the display assembly 1210, or combinations thereof. Example optical elements may include an aperture, a Fresnel lens, a convex lens, a concave lens, a filter, a polarizer, or any other suitable optical element that may affect image light.

In some embodiments, the display assembly 1210 may include a source assembly to generate image light to present media to a user's eyes. The source assembly may include, e.g., a light source, an optics system, or some combination thereof. In accordance with various embodiments, a source assembly may include a light-emitting diode (LED) such as an organic light-emitting diode (OLED).

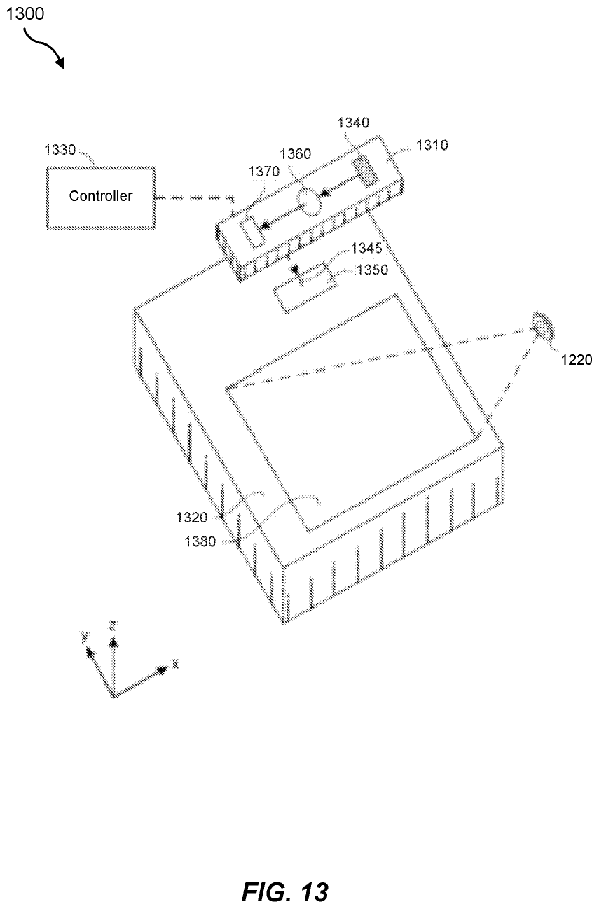

FIG. 13 illustrates an isometric view of a waveguide display in accordance with some embodiments. The waveguide display 1300 may be a component (e.g., display assembly 1210) of NED 1100. In alternate embodiments, the waveguide display 1300 may constitute a part of some other NED, or other system that directs display image light to a particular location.

The waveguide display 1300 may include a source assembly 1310, an output waveguide 1320, and a controller 1330. For purposes of illustration, FIG. 13 shows the waveguide display 1300 associated with a single eye 1220, but in some embodiments, another waveguide display separate (or partially separate) from the waveguide display 1300 may provide image light to another eye of the user. In a partially separate system, one or more components may be shared between waveguide displays for each eye.

The source assembly 1310 generates image light. The source assembly 1310 may include a source 1340, a light conditioning assembly 1360, and a scanning mirror assembly 1370. The source assembly 1310 may generate and output image light 1345 to a coupling element 1350 of the output waveguide 1320. Image light may include linearly polarized light, for example.

The source 1340 may include a source of light that generates coherent or partially coherent image light 1345. The source 1340 may emit light in accordance with one or more illumination parameters received from the controller 1330. The source 1340 may include one or more source elements, including, but not restricted to light emitting diodes, such as micro-OLEDs.

The output waveguide 1320 may be configured as an optical waveguide that outputs image light to an eye 1220 of a user. The output waveguide 1320 receives the image light 1345 through one or more coupling elements 1350 and guides the received input image light 1345 to one or more decoupling elements 1380. In some embodiments, the coupling element 1350 couples the image light 1345 from the source assembly 1310 into the output waveguide 1320. The coupling element 1350 may be or include a diffraction grating, a holographic grating, some other element that couples the image light 1345 into the output waveguide 1320, or some combination thereof. For example, in embodiments where the coupling element 1350 is a diffraction grating, the pitch of the diffraction grating may be chosen such that total internal reflection occurs, and the image light 1345 propagates internally toward the decoupling element 1380. For example, the pitch of the diffraction grating may be in the range of approximately 1300 nm to approximately 1600 nm.

The decoupling element 1380 decouples the total internally reflected image light from the output waveguide 1320. The decoupling element 1380 may be or include a diffraction grating, a holographic grating, some other element that decouples image light out of the output waveguide 1320, or some combination thereof. For example, in embodiments where the decoupling element 1380 is a diffraction grating, the pitch of the diffraction grating may be chosen to cause incident image light to exit the output waveguide 1320. An orientation and position of the image light exiting from the output waveguide 1320 may be controlled by changing an orientation and position of the image light 1345 entering the coupling element 1350.

The output waveguide 1320 may be composed of one or more materials that facilitate total internal reflection of the image light 1345. The output waveguide 1320 may be composed of, for example, silicon, glass, or a polymer, or some combination thereof. The output waveguide 1320 may have a relatively small form factor such as for use in a head-mounted display. For example, the output waveguide 1320 may be approximately 30 mm wide along an x-dimension, 50 mm long along a y-dimension, and 0.5-1 mm thick along a z-dimension. In some embodiments, the output waveguide 1320 may be a planar (2D) optical waveguide.

The controller 1330 may be used to control the scanning operations of the source assembly 1310. In certain embodiments, the controller 1330 may determine scanning instructions for the source assembly 1310 based at least on one or more display instructions. Display instructions may include instructions to render one or more images. In some embodiments, display instructions may include an image file (e.g., bitmap). The display instructions may be received from, e.g., a console of a virtual reality system (not shown). Scanning instructions may include instructions used by the source assembly 1310 to generate image light 1345. The scanning instructions may include, e.g., a type of a source of image light (e.g., monochromatic, polychromatic), a scanning rate, an orientation of scanning mirror assembly 1370, and/or one or more illumination parameters, etc. The controller 1330 may include a combination of hardware, software, and/or firmware not shown here so as not to obscure other aspects of the disclosure.

According to some embodiments, source 1340 may include a light emitting diode (LED), such as an organic light emitting diode (OLED). An organic light-emitting diode (OLED) is a light-emitting diode (LED) having an emissive electroluminescent layer that may include a thin film of an organic compound that emits light in response to an electric current. The organic layer is typically situated between a pair of conductive electrodes. One or both of the electrodes may be optically transparent.

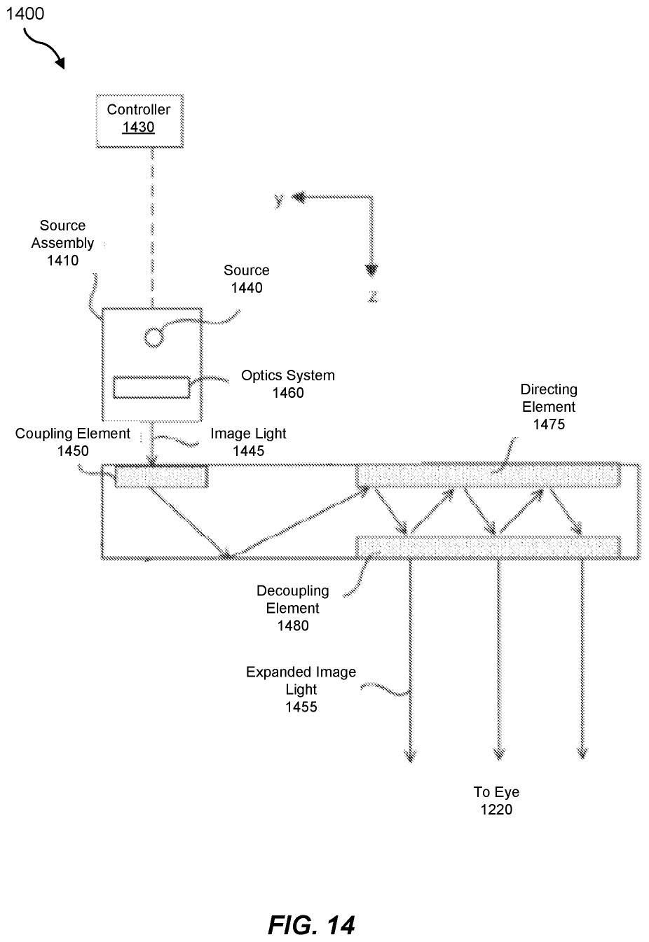

FIG. 14 illustrates an embodiment of a cross section of a waveguide display. The waveguide display 1400 includes a source assembly 1410 configured to generate image light 1445 in accordance with scanning instructions from controller 1430. The source assembly 1410 includes a source 1440 and an optics system 1460. The source 1440 may be a light source that generates coherent or partially coherent light. The source 1440 may include, e.g., a laser diode, a vertical cavity surface emitting laser, and/or a light emitting diode.

The optics system 1460 may include one or more optical components configured to condition the light from the source 1440. Conditioning light from the source 1440 may include, e.g., expanding, collimating, and/or adjusting orientation in accordance with instructions from the controller 1430. The one or more optical components may include one or more of a lens, liquid lens, mirror, aperture, and/or grating. In some embodiments, the optics system 1460 includes a liquid lens with a plurality of electrodes that allows scanning a beam of light with a threshold value of scanning angle to shift the beam of light to a region outside the liquid lens. Light emitted from the optics system 1460 (and also the source assembly 1410) is referred to as image light 1445.

The output waveguide 1420 receives the image light 1445. Coupling element 1450 couples the image light 1445 from the source assembly 1410 into the output waveguide 1420. In embodiments where the coupling element 1450 is a diffraction grating, a pitch of the diffraction grating may be chosen such that total internal reflection occurs in the output waveguide 1420, and the image light 1445 propagates internally in the output waveguide 1420 (e.g., by total internal reflection) toward decoupling element 1480.

A directing element 1475 may be configured to redirect the image light 1445 toward the decoupling element 1480 for decoupling from the output waveguide 1420. In embodiments where the directing element 1475 is a diffraction grating, the pitch of the diffraction grating may be chosen to cause incident image light 1445 to exit the output waveguide 1420 at angle(s) of inclination relative to a surface of the decoupling element 1480.

In some embodiments, the directing element 1475 and/or the decoupling element 1480 may be structurally similar. The expanded image light 1455 exiting the output waveguide 1420 may be expanded along one or more dimensions (e.g., may be elongated along an x-dimension).

In some embodiments, the waveguide display 1400 may include a plurality of source assemblies 1410 and a plurality of output waveguides 1420. Each of the source assemblies 1410 may be configured to emit monochromatic image light of a specific band of wavelength corresponding to a primary color (e.g., red, yellow, or blue). Each of the output waveguides 1420 may be stacked together with a distance of separation to output expanded image light 1455 that is multi-colored.

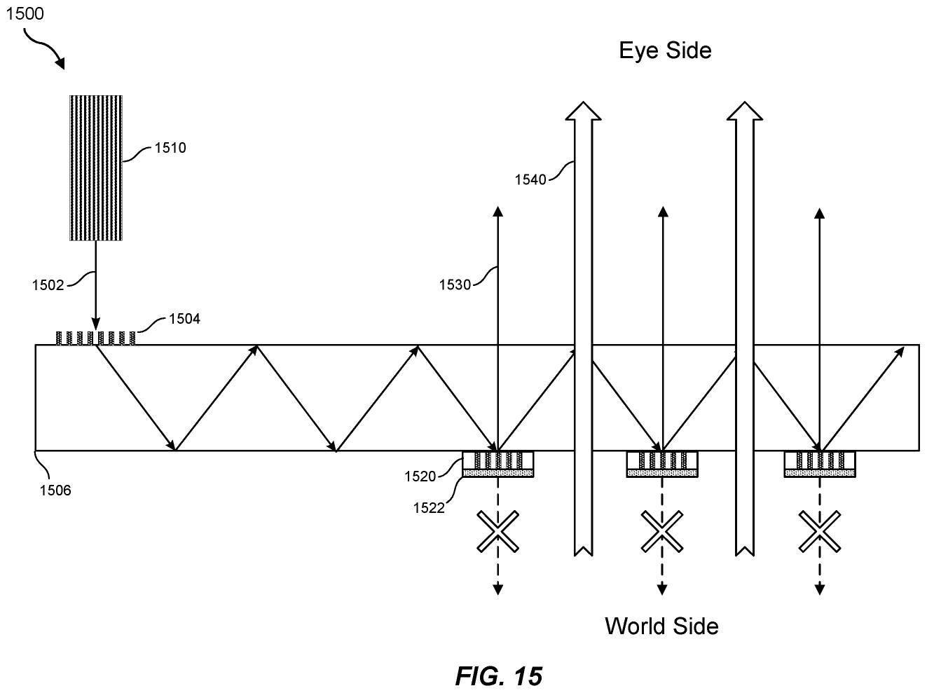

Referring to FIG. 15, shown is a cross-sectional view of a further waveguide display 1500. The display projector 1510 includes a source of image light 1502 and waveguide optics for expanding and directing the image light 1502 to the eye of a user. The image light 1502 is coupled into a waveguide 1506 through an input grating 1504 and, following one or more reflections within the waveguide 1506, coupled out of the waveguide through an output grating array and directed to the eye of a user.

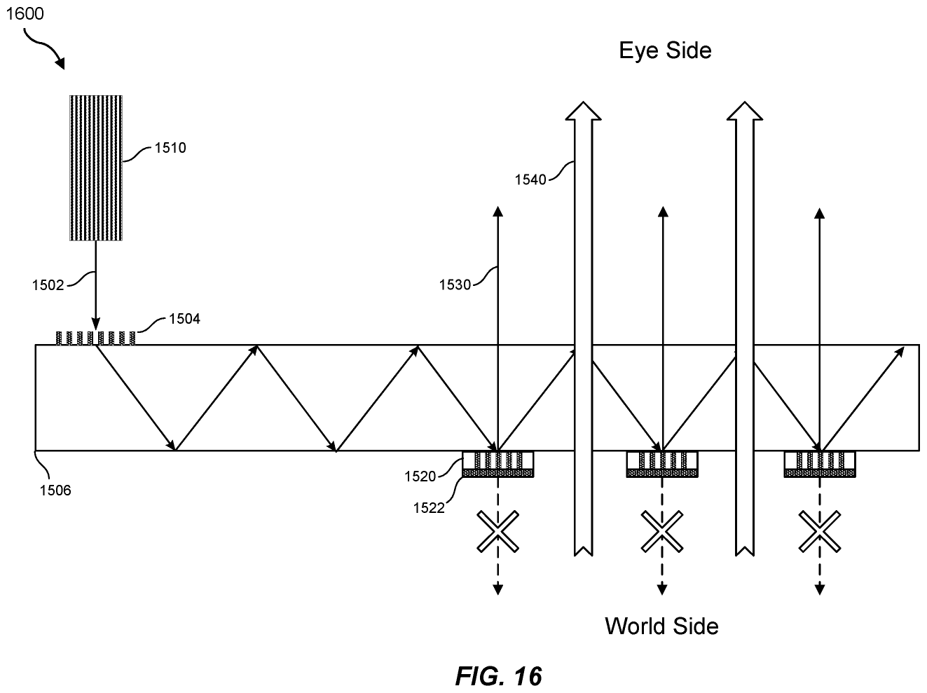

In the illustrated embodiment, the output grating array includes a plurality of discrete and spaced apart output gratings 1520 for decoupling the light and a reflector 1522 overlying each respective output grating for redirecting light decoupled to the world side of the waveguide display back to the user's eye as image light 1530. In some examples, light 1540 from the world side may also reach the user's eye. As shown in FIG. 15, the reflector layers may be formed from a material that is different than the material used to form the individual grating elements. As shown in FIG. 16, the reflector layers and the grating elements may be formed from the same reflective material.

In one example, a waveguide display may include a waveguide substrate and a plurality of decoupling elements for decoupling image light from the substrate. Discrete decoupling elements may be arranged as an array within a decoupling region of the display and may include a binary or slanted grating architecture, for example. The decoupling elements may each additionally include an overlying reflective layer on the world side of the waveguide substrate. The reflective layers may be configured to inhibit the transmission of decoupled light to the world side of the display and correspondingly increase the amount of image light coupled to the eye of a user, thus significantly increasing component level diffraction efficiency. The reflective layers may include any suitable reflective material such as a metal thin film. For augmented reality applications, gaps between the decoupling elements within the decoupling region may be filled with an optically transparent material that allows real world light to reach the user's eye.

In one example, a method of manufacture for a light-recycling waveguide device may include coupling an output coupler to a waveguide such that the output coupler couples electromagnetic radiation from within the waveguide to outside of the waveguide. The method may also include disposing a reflector on an opposite side of the waveguide from the output coupler such that the reflector reflects electromagnetic radiation that leaks from the waveguide through the opposite side of the waveguide back toward the output coupler.

Embodiments of the present disclosure may include or be implemented in conjunction with various types of artificial-reality systems. Artificial reality may be a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

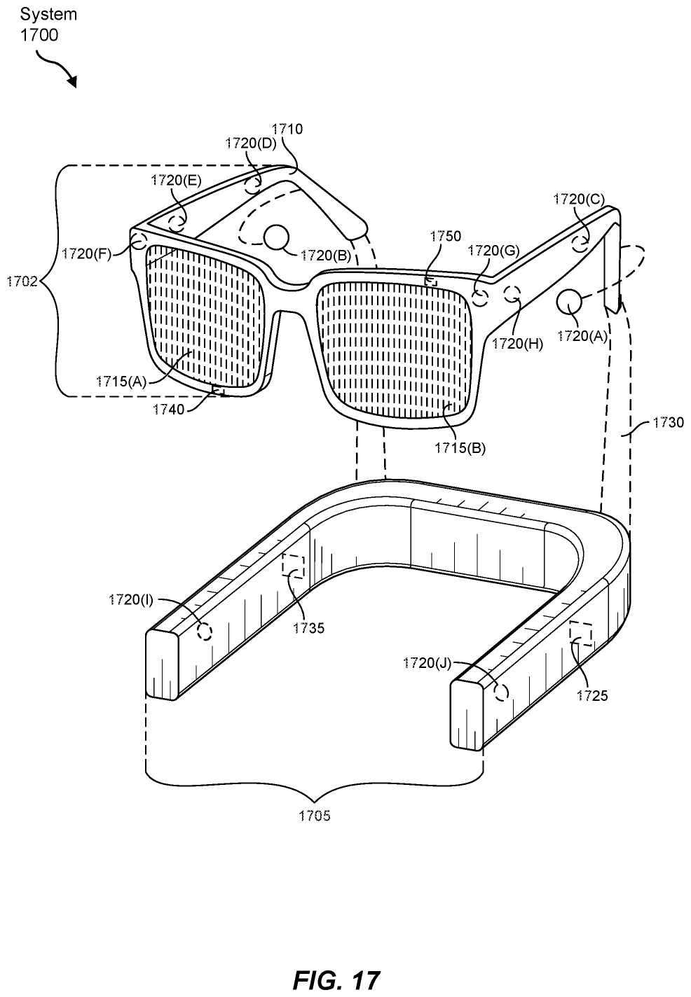

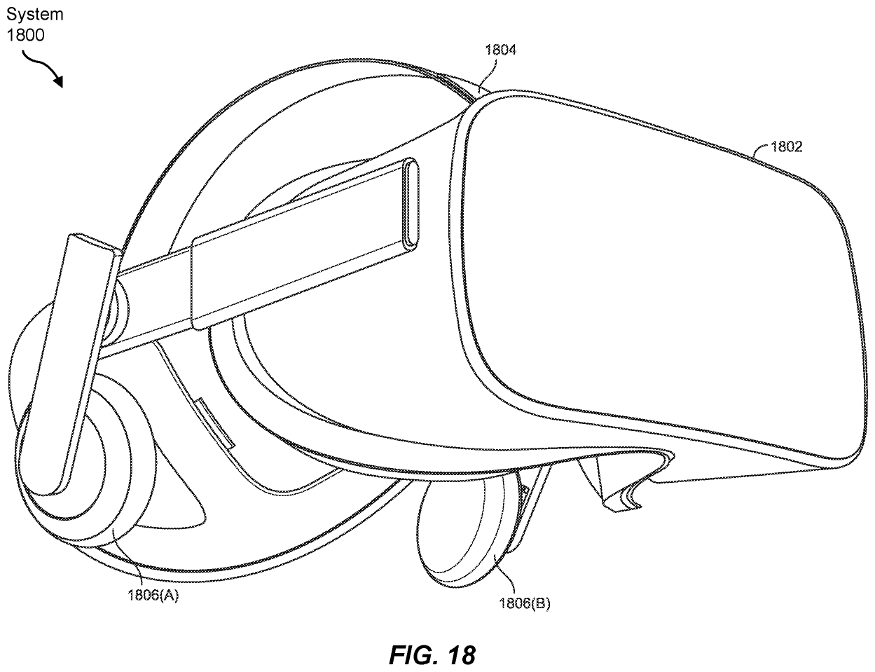

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1700 in FIG. 17) or that visually immerses a user in an artificial reality (such as, e.g., virtual-reality system 1800 in FIG. 18). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 17, augmented-reality system 1700 may include an eyewear device 1702 with a frame 1710 configured to hold a left display device 1715(A) and a right display device 1715(B) in front of a user's eyes. Display devices 1715(A) and 1715(B) may act together or independently to present an image or series of images to a user. While augmented-reality system 1700 includes two displays, embodiments of this disclosure may be implemented in augmented-reality systems with a single NED or more than two NEDs.

In some embodiments, augmented-reality system 1700 may include one or more sensors, such as sensor 1740. Sensor 1740 may generate measurement signals in response to motion of augmented-reality system 1700 and may be located on substantially any portion of frame 1710. Sensor 1740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1700 may or may not include sensor 1740 or may include more than one sensor. In embodiments in which sensor 1740 includes an IMU, the IMU may generate calibration data based on measurement signals from sensor 1740. Examples of sensor 1740 may include, without limitation, accelerometers, gyroscopes, magnetometers, other suitable types of sensors that detect motion, sensors used for error correction of the IMU, or some combination thereof.

In some examples, augmented-reality system 1700 may also include a microphone array with a plurality of acoustic transducers 1720(A)-1720(J), referred to collectively as acoustic transducers 1720. Acoustic transducers 1720 may represent transducers that detect air pressure variations induced by sound waves. Each acoustic transducer 1720 may be configured to detect sound and convert the detected sound into an electronic format (e.g., an analog or digital format). The microphone array in FIG. 17 may include, for example, ten acoustic transducers: 1720(A) and 1720(B), which may be designed to be placed inside a corresponding ear of the user, acoustic transducers 1720(C), 1720(D), 1720(E), 1720(F), 1720(G), and 1720(H), which may be positioned at various locations on frame 1710, and/or acoustic transducers 1720(1) and 1720(J), which may be positioned on a corresponding neckband 1705.

In some embodiments, one or more of acoustic transducers 1720(A)-(J) may be used as output transducers (e.g., speakers). For example, acoustic transducers 1720(A) and/or 1720(B) may be earbuds or any other suitable type of headphone or speaker.

The configuration of acoustic transducers 1720 of the microphone array may vary. While augmented-reality system 1700 is shown in FIG. 17 as having ten acoustic transducers 1720, the number of acoustic transducers 1720 may be greater or less than ten. In some embodiments, using higher numbers of acoustic transducers 1720 may increase the amount of audio information collected and/or the sensitivity and accuracy of the audio information. In contrast, using a lower number of acoustic transducers 1720 may decrease the computing power required by an associated controller 1750 to process the collected audio information. In addition, the position of each acoustic transducer 1720 of the microphone array may vary. For example, the position of an acoustic transducer 1720 may include a defined position on the user, a defined coordinate on frame 1710, an orientation associated with each acoustic transducer 1720, or some combination thereof.

Acoustic transducers 1720(A) and 1720(B) may be positioned on different parts of the user's ear, such as behind the pinna, behind the tragus, and/or within the auricle or fossa. Or, there may be additional acoustic transducers 1720 on or surrounding the ear in addition to acoustic transducers 1720 inside the ear canal. Having an acoustic transducer 1720 positioned next to an ear canal of a user may enable the microphone array to collect information on how sounds arrive at the ear canal. By positioning at least two of acoustic transducers 1720 on either side of a user's head (e.g., as binaural microphones), augmented-reality device 1700 may simulate binaural hearing and capture a 3D stereo sound field around about a user's head. In some embodiments, acoustic transducers 1720(A) and 1720(B) may be connected to augmented-reality system 1700 via a wired connection 1730, and in other embodiments acoustic transducers 1720(A) and 1720(B) may be connected to augmented-reality system 1700 via a wireless connection (e.g., a BLUETOOTH connection). In still other embodiments, acoustic transducers 1720(A) and 1720(B) may not be used at all in conjunction with augmented-reality system 1700.

Acoustic transducers 1720 on frame 1710 may be positioned in a variety of different ways, including along the length of the temples, across the bridge, above or below display devices 1715(A) and 1715(B), or some combination thereof. Acoustic transducers 1720 may also be oriented such that the microphone array is able to detect sounds in a wide range of directions surrounding the user wearing the augmented-reality system 1700. In some embodiments, an optimization process may be performed during manufacturing of augmented-reality system 1700 to determine relative positioning of each acoustic transducer 1720 in the microphone array.

In some examples, augmented-reality system 1700 may include or be connected to an external device (e.g., a paired device), such as neckband 1705. Neckband 1705 generally represents any type or form of paired device. Thus, the following discussion of neckband 1705 may also apply to various other paired devices, such as charging cases, smart watches, smart phones, wrist bands, other wearable devices, hand-held controllers, tablet computers, laptop computers, other external compute devices, etc.

As shown, neckband 1705 may be coupled to eyewear device 1702 via one or more connectors. The connectors may be wired or wireless and may include electrical and/or non-electrical (e.g., structural) components. In some cases, eyewear device 1702 and neckband 1705 may operate independently without any wired or wireless connection between them. While FIG. 17 illustrates the components of eyewear device 1702 and neckband 1705 in example locations on eyewear device 1702 and neckband 1705, the components may be located elsewhere and/or distributed differently on eyewear device 1702 and/or neckband 1705. In some embodiments, the components of eyewear device 1702 and neckband 1705 may be located on one or more additional peripheral devices paired with eyewear device 1702, neckband 1705, or some combination thereof.

Pairing external devices, such as neckband 1705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1700 may be provided by a paired device or shared between a paired device and an eyewear device, thus reducing the weight, heat profile, and form factor of the eyewear device overall while still retaining desired functionality. For example, neckband 1705 may allow components that would otherwise be included on an eyewear device to be included in neckband 1705 since users may tolerate a heavier weight load on shoulders than they would tolerate on heads. Neckband 1705 may also have a larger surface area over which to diffuse and disperse heat to the ambient environment. Thus, neckband 1705 may allow for greater battery and computation capacity than might otherwise have been possible on a stand-alone eyewear device. Since weight carried in neckband 1705 may be less invasive to a user than weight carried in eyewear device 1702, a user may tolerate wearing a lighter eyewear device and carrying or wearing the paired device for greater lengths of time than a user would tolerate wearing a heavy standalone eyewear device, thereby enabling users to more fully incorporate artificial-reality environments into day-to-day activities.

Neckband 1705 may be communicatively coupled with eyewear device 1702 and/or to other devices. These other devices may provide certain functions (e.g., tracking, localizing, depth mapping, processing, storage, etc.) to augmented-reality system 1700. In the embodiment of FIG. 17, neckband 1705 may include two acoustic transducers (e.g., 1720(l) and 1720(J)) that are part of the microphone array (or potentially form own microphone subarray). Neckband 1705 may also include a controller 1725 and a power source 1735.

Acoustic transducers 1720(l) and 1720(J) of neckband 1705 may be configured to detect sound and convert the detected sound into an electronic format (analog or digital). In the embodiment of FIG. 17, acoustic transducers 1720(l) and 1720(J) may be positioned on neckband 1705, thereby increasing the distance between the neckband acoustic transducers 1720(l) and 1720(J) and other acoustic transducers 1720 positioned on eyewear device 1702. In some cases, increasing the distance between acoustic transducers 1720 of the microphone array may improve the accuracy of beamforming performed via the microphone array. For example, if a sound is detected by acoustic transducers 1720(C) and 1720(D) and the distance between acoustic transducers 1720(C) and 1720(D) is greater than, e.g., the distance between acoustic transducers 1720(D) and 1720(E), the determined source location of the detected sound may be more accurate than if the sound had been detected by acoustic transducers 1720(D) and 1720(E).

Controller 1725 of neckband 1705 may process information generated by the sensors on neckband 1705 and/or augmented-reality system 1700. For example, controller 1725 may process information from the microphone array that describes sounds detected by the microphone array. For each detected sound, controller 1725 may perform a direction-of-arrival (DOA) estimation to estimate a direction from which the detected sound arrived at the microphone array. As the microphone array detects sounds, controller 1725 may populate an audio data set with the information. In embodiments in which augmented-reality system 1700 includes an inertial measurement unit, controller 1725 may compute all inertial and spatial calculations from the IMU located on eyewear device 1702. A connector may convey information between augmented-reality system 1700 and neckband 1705 and between augmented-reality system 1700 and controller 1725. The information may be in the form of optical data, electrical data, wireless data, or any other transmittable data form. Moving the processing of information generated by augmented-reality system 1700 to neckband 1705 may reduce weight and heat in eyewear device 1702, making it more comfortable to the user.

Power source 1735 in neckband 1705 may provide power to eyewear device 1702 and/or to neckband 1705. Power source 1735 may include, without limitation, lithium-ion batteries, lithium-polymer batteries, primary lithium batteries, alkaline batteries, or any other form of power storage. In some cases, power source 1735 may be a wired power source. Including power source 1735 on neckband 1705 instead of on eyewear device 1702 may help better distribute the weight and heat generated by power source 1735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1800 in FIG. 18, that mostly or completely covers a user's field of view. Virtual-reality system 1800 may include a front rigid body 1802 and a band 1804 shaped to fit around a user's head. Virtual-reality system 1800 may also include output audio transducers 1806(A) and 1806(B). Furthermore, while not shown in FIG. 18, front rigid body 1802 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1700 and/or virtual-reality system 1800 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1700 and/or virtual-reality system 1800 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1700 and/or virtual-reality system 1800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A device comprising:
a waveguide;
an output coupler that couples electromagnetic radiation from within the waveguide to outside of the waveguide; and
a reflector positioned on an opposite side of the waveguide from the output coupler, wherein the reflector reflects electromagnetic radiation that leaks from the waveguide through the opposite side of the waveguide back toward the output coupler.

2. The device of claim 1, further comprising a transmissive polarization volume hologram positioned between the reflector and the waveguide.

3. The device of claim 2, wherein the transmissive polarization volume hologram is configured to redirect electromagnetic radiation reentering the waveguide from the reflector toward at least one interpupil replication location.

4. The device of claim 1, wherein the reflector comprises a reflective cholesteric liquid crystal polymer film.

5. The device of claim 1, wherein the reflector comprises a 50:50 mirror.

6. The device of claim 1, wherein the reflector comprises a reflective polarizer.

7. The device of claim 6, wherein the reflector further comprises an achromatic quarter-wave plate.

8. The device of claim 1, wherein the reflector comprises a reflective polarization volume hologram.

9. The device of claim 8, wherein the reflective polarization volume hologram has periodic variation to reflect both normally incident and total-internal-reflection incident electromagnetic radiation.

10. The device of claim 1, further comprising at least depolarizer placed on a side of the waveguide and between the output coupler and an input coupler.

11. A system comprising:
a head-mounted display, comprising:
a waveguide;
an output coupler that couples electromagnetic radiation from within the waveguide toward an eye box of the head-mounted display; and
a reflector positioned on an opposite side of the waveguide from the output coupler, wherein the reflector reflects electromagnetic radiation that leaks from the waveguide through the opposite side of the waveguide back toward the output coupler.

12. The system of claim 11, further comprising a transmissive polarization volume hologram positioned between the reflector and the waveguide.

13. The system of claim 12, wherein the transmissive polarization volume hologram is configured to redirect electromagnetic radiation reentering the waveguide from the reflector toward at least one interpupil replication location.

14. The system of claim 11, wherein the reflector comprises a reflective cholesteric liquid crystal polymer film.

15. The system of claim 11, wherein the reflector comprises a 50:50 mirror.

16. The system of claim 11, wherein the reflector comprises a reflective polarizer.

17. The system of claim 16, wherein the reflector further comprises an achromatic quarter-wave plate.

18. The system of claim 11, wherein the reflector comprises a reflective polarization volume hologram.

19. The system of claim 18, wherein the reflective polarization volume hologram has periodic variation to reflect both normally incident and total-internal-reflection incident electromagnetic radiation.

20. A method of manufacture comprising:
coupling an output coupler to a waveguide such that the output coupler couples electromagnetic radiation from within the waveguide to outside of the waveguide; and
disposing a reflector on an opposite side of the waveguide from the output coupler such that the reflector reflects electromagnetic radiation that leaks from the waveguide through the opposite side of the waveguide back toward the output coupler.
